(19) United States
(12) Patent Application Publication
(10) Pub. No.: US 2016/0352370 A1
(43) Pub. Date: Dec. 1, 2016

(54) LOCAL OSCILLATION SIGNAL LEVEL ADJUSTMENT CIRCUIT, LOCAL OSCILLATION SIGNAL LEVEL ADJUSTMENT METHOD, AND WIRELESS COMMUNICATION DEVICE

(71) Applicant: Panasonic Intellectual Property Management Co., Ltd., Osaka (JP)

(72) Inventors: KAZUTOSHI SATOU, Kanagawa (JP); MASAKI KANEMARU, Tokyo (JP)

(21) Appl. No.: 15/156,332

(22) Filed: May 17, 2016

(30) Foreign Application Priority Data
Jun. 1, 2015 (JP) 2015-111148
Feb. 12, 2016 (JP) 2016-025120

(51) Int. Cl. H04B 1/16

(52) U.S. Cl. CPC H04B 1/16

(57) ABSTRACT

A local oscillation signal level adjustment circuit includes: a local oscillation circuit that outputs a local oscillation signal; a variable gain amplifier that amplifies the local oscillation signal level; a frequency conversion circuit that converts a radio signal into an analog baseband signal by using the local oscillation signal thus amplified; an A/D converter that converts the analog baseband signal into an output code of a digital baseband signal; and a control circuit that controls a gain of the variable gain amplifier on a basis of the output code of the digital baseband signal, wherein the control circuit increases the gain of the variable gain amplifier until the output code of the digital baseband signal becomes saturated.

### BACKGROUND

1. Technical Field

The present disclosure relates to a local oscillation signal level adjustment circuit that is used in a wireless communication device, a local oscillation signal level adjustment method that is used in a wireless communication device, and a wireless communication device.

2. Description of the Related Art

A currently widely-used wireless communication device receives a radio frequency signal, down-coverts the radio frequency signal into a baseband by using a frequency conversion circuit, and then performs demodulated signal processing. In conventional frequency conversion, an output signal (local oscillation signal) from a local oscillation circuit has been inputted to the frequency conversion circuit. However, if there is a decrease in the local oscillation signal level, for example, due to a change in temperature, there may be a decrease in the conversion gain of the frequency conversion circuit.

Various methods have been proposed as methods for reducing variations in conversion gain. For example, if there is a change in temperature, a circuit that detects the level of a local oscillation signal adjusts the local oscillation signal to a certain level (for example, see Japanese Unexamined Patent Application Publication No. 2003-32048).

The local oscillation signal level adjustment circuit disclosed in Japanese Unexamined Patent Application Publication No. 2003-32048 detects the level of a local oscillation signal that is inputted to the frequency conversion circuit, compares the local oscillation signal with a reference DC signal, and adjusts the local oscillation signal to a certain level.

However, the technology disclosed in Japanese Unexamined Patent Application Publication No. 2003-32048 has imposed the following requirements. The circuit that detects the level of a local oscillation signal tends to suffer from fluctuations in characteristic, for example, due to production tolerance or fluctuations in temperature. Therefore, the circuit that detects the level of a local oscillation signal needs to be calibrated by an external reference signal for higher detection accuracy. Radio frequency signals in a millimeter-wave band make it difficult to perform calibration with high accuracy. This leads to inaccuracy in the adjustment of the level of a local oscillation signal by the built-in local oscillation signal level detection circuit.

### SUMMARY

One non-limiting and exemplary embodiment provides a local oscillation signal level adjustment circuit, a local oscillation signal level adjustment method, and a wireless communication device that make it possible to adjust the level of a local oscillation signal with high accuracy.

In a conventional wireless communication device in which a received signal and a local oscillation signal are at the same frequency, as in the case of direction conversion, there occurs an operation called self-mixing in which a local oscillation signal inputted to a frequency conversion circuit returns from the input of the frequency conversion circuit via a preceding circuit. Therefore, in the conventional wireless communication device, a DC offset voltage is generated at the output of the frequency conversion circuit. The DC offset voltage moves in tandem with the conversion gain, which changes according to the local oscillation signal level. As with the conversion gain, the DC offset voltage becomes higher according to an increase in the local oscillation signal level and then becomes saturated.

In one general aspect, the techniques disclosed here feature a local oscillation signal level adjustment circuit including: a local oscillation circuit that outputs a local oscillation signal; a variable gain amplifier that amplifies the local oscillation signal level; a frequency conversion circuit that converts a radio signal into an analog baseband signal by using the local oscillation signal level thus amplified; an A/D converter that converts the analog baseband signal into an output code of a digital baseband signal; and a control circuit that controls a gain of the variable gain amplifier on a basis of the output code of the digital baseband signal, wherein the control circuit increases the gain of the variable gain amplifier until the output code of the digital baseband signal becomes saturated.

In one general aspect, the local oscillation signal level adjustment circuit makes it possible to omit a conventionally-needed circuit that detects the level of a local oscillation signal and, what is more, makes it possible to adjust the level of a local oscillation signal level with high accuracy.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 shows an example configuration of a wireless communication device 1 according to Embodiment 1 of the present disclosure;

FIG. 2 shows a procedure for adjusting a local oscillation signal level; and

FIG. 3 shows an example configuration of a wireless communication device 1A according to Embodiment 2 of the present disclosure.

### DETAILED DESCRIPTION

Embodiments of the present disclosure are described below with reference to the drawings. Note, however, that like reference numerals are used to indicate components having similar functions and the associated description is not repeated.

### Embodiment 1

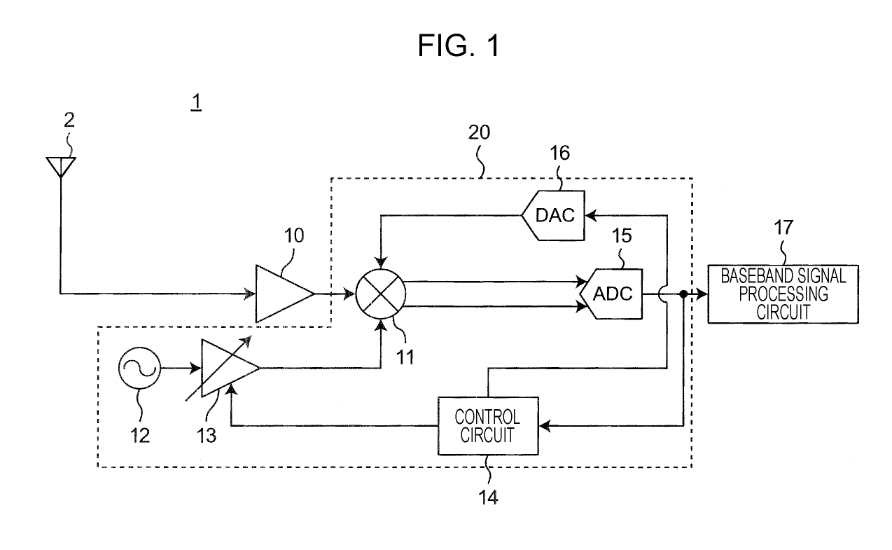

FIG. 1 is a block diagram showing an example configuration of a wireless communication device 1 according to Embodiment 1 of the present disclosure. The following describes a configuration of the wireless communication device 1 with reference to FIG. 1. The wireless communication device 1 of FIG. 1 illustrates a configuration of a radio receiver. However, the present disclosure is not limited to this illustration. The wireless communication device 1 may include a configuration of a radio transmitter.

In FIG. 1, the wireless communication device 1 includes an antenna 2, a low noise amplifier (hereinafter referred to as “LNA”) 10, a local oscillation signal level adjustment circuit 20, and a baseband signal processing circuit 17.

The local oscillation signal level adjustment circuit 20 includes a frequency conversion circuit 11, a local oscillation circuit 12, a variable gain amplifier 13, a control circuit 14, an A/D converter (ADC) 15, and a D/A converter (DAC) 16.

The LNA 10 receives a radio signal from the antenna 2, amplifies the radio signal, and outputs the radio signal to the frequency conversion circuit 11. The local oscillation circuit 12 generates a local oscillation signal that is stable at a constant frequency, and outputs the local oscillation signal to the variable gain amplifier 13. The gain of the variable gain amplifier 13 can be varied by the control circuit 14. The variable gain amplifier 13 amplifies the local oscillation signal, which an output signal from the local oscillation circuit 12, and outputs the local oscillation signal to the frequency conversion circuit 11. The frequency conversion circuit 11 includes a mixer constituted by using a plurality of MOS (metal-oxide semiconductor) transistors and a low-pass filter (LPF). The frequency conversion circuit 11 receives the radio signal from the LNA 10 and the local oscillation signal from the variable gain amplifier 13, mixes the radio signal with the local oscillation signal, and thereby down-converts the mixed signal, for example, into an analog baseband signal (differential output signal) of a differential signal format. The frequency conversion circuit 11 outputs the analog baseband signal to the A/D converter 15. The A/D converter 15 converts the analog baseband signal into a digital baseband signal.

In the frequency conversion circuit 11, a DC offset voltage is generated in the analog baseband signal of the frequency conversion circuit 11 due to production tolerance. Note here that it is difficult to use AC coupling in a wireless communication device using radio frequency signals in a conventional millimeter-wave band. For this reason, the wireless communication device 1 compensates for the DC offset voltage with DC coupling. For such occasions, the control circuit 14 detects an output code (signal formed by a plurality of bits) of the digital baseband signal of the A/D converter 15 that changes according to the DC offset voltage of the analog baseband signal that is inputted to the A/D converter 15, and compensates for the DC offset voltage of the analog baseband signal of the frequency conversion circuit 11 by using the D/A converter 16. Specifically, the control circuit 14 generates a digital control signal (digital voltage) for adjusting the DC offset voltage of the analog baseband signal of the frequency conversion circuit 11. The D/A converter 16 converts the digital control signal into an analog control signal (analog voltage) and outputs the analog control signal to the mixer of the frequency conversion circuit 11.

The A/D converter 15 outputs the output code of the digital baseband signal to the baseband signal processing circuit 17. The baseband signal processing circuit 17 for example demodulates the output code (received radio signal) of the digital baseband signal and outputs the demodulated signal.

The control circuit 14 is a hardware controller and, for example, is a computer that controls the operation of the wireless communication device 1 by using a memory. The control circuit 14 controls the gain of the variable gain amplifier 13 on the basis of the output code of the digital baseband signal of the A/D converter 15 that changes according to the DC offset voltage of the analog baseband signal that is inputted to the A/D converter 15.

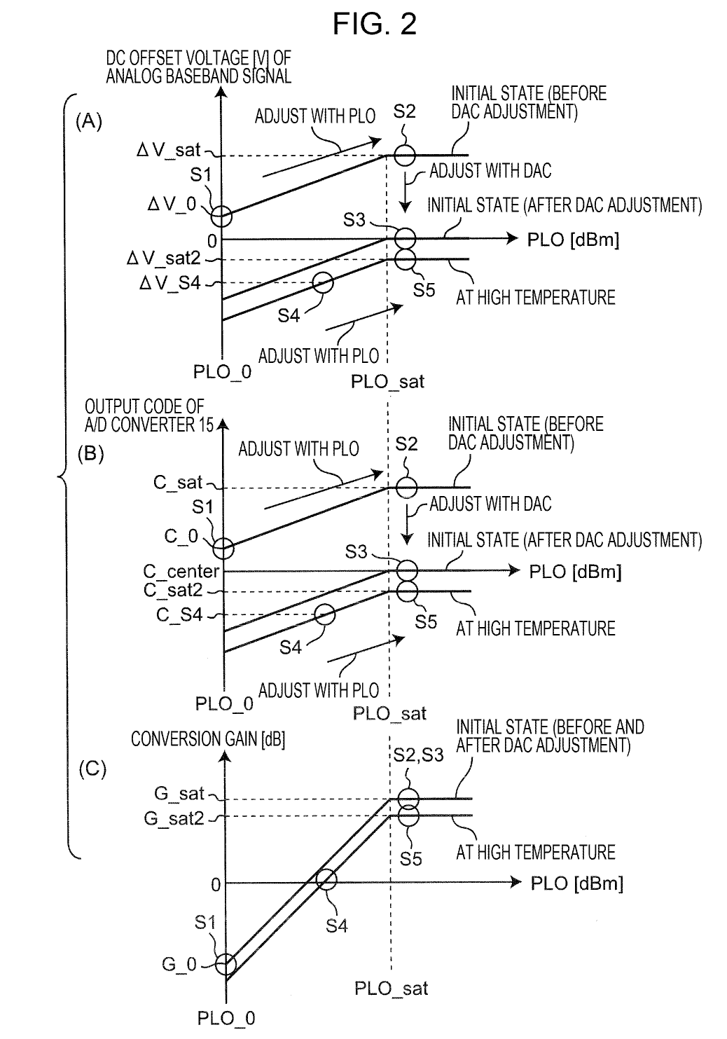

A procedure for adjusting the level of a local oscillation signal is described with reference to FIG. 2. FIG. 2 shows (A) the DC offset voltage of the analog baseband signal outputted from the frequency conversion circuit 11, (B) the output code of the digital baseband signal outputted from the A/D converter 15, and (C) the conversion gain of the frequency conversion circuit 11 in the case of a change in local oscillation signal level (hereinafter referred to as “PLO (Power of Local Output)”) of the variable gain amplifier 13.

First, the control circuit 14 sets the PLO to PLO_0 (initial value) (state S1). In the state S1, the conversion gain of the frequency conversion circuit 11 is G_0 ((C) of FIG. 2). The control circuit 14 uses the output code of the digital baseband signal of the A/D converter 15 to estimate the DC offset voltage of the analog baseband signal that is outputted from the frequency conversion circuit 11. When the DC offset voltage is ΔV_0, the output code of the digital baseband signal of the A/D converter 15 is C_0 (state S1).

Next, in order to bring the frequency conversion circuit 11 into an optimum operating state, the control circuit 14 makes an adjustment to increase the PLO to a value that is close to an optimum value PLO_sat until the conversion gain of the frequency conversion circuit 11 becomes a saturated conversion gain G_sat as shown in (C) of FIG. 2 (transition from the state S1 to a state S2). The increase in the PLO causes the DC offset voltage of the analog baseband signal to be higher than ΔV_0 in tandem with the conversion gain of the frequency conversion circuit 11. Then, as shown in (B) of FIG. 2, the output code of the digital baseband signal of the A/D converter 15 becomes greatly shifted from a value C_center (initial adjustment value) corresponding to an analog baseband signal that is outputted in a case where the DC offset voltage of the analog baseband signal is 0 V. The value C_center is half as large as an output full-scale value. That is, in the transition from the state S1 to the state S2, the output code of the digital baseband signal of the A/D converter 15 becomes larger in the same manner as the change in the DC offset voltage. This allows the control circuit 14 to use the output code of the digital baseband signal of the A/D converter 15 to estimate the DC offset voltage of the analog baseband signal outputted from the frequency conversion circuit 11.

Further, in a case where the control circuit 14 has increased the PLO until the conversion gain of the frequency conversion circuit 11 becomes the saturated conversion gain G_sat, the DC offset voltage of the analog baseband signal becomes saturated as ΔV_sat, and the output code of the digital baseband signal of the A/D converter 15 increases to a bit sequence signal (C_sat) of a certain value. The control circuit 14 can adjust the PLO to the optimum value PLO_sat by gradually increasing the gain of the variable gain amplifier 13 until the output code of the digital baseband signal of the A/D converter 15 becomes saturated as C_sat (i.e., until the bit sequence signal reaches a certain value (e.g., the maximum value)).

Furthermore, the control circuit 14 outputs, to the D/A converter 16, a digital control signal for compensating the output code of the digital baseband signal of the A/D converter 15 to the initial adjustment value C_center and uses the D/A converter 16 to compensate for the DC offset voltage of the analog baseband signal of the frequency conversion circuit 11 so that the DC offset voltage becomes 0 V (initial adjustment: adjustment from the state S2 to a state S3). That is, the frequency conversion circuit 11 converts the radio signal into an compensated analog baseband signal by using the digital control signal and the local oscillation signal level thus amplified. This brings the wireless communication device 1 into a normal operating state (state S3). The following describes an operation for making an adjustment in a state of characteristic change at a high temperature after having made the initial adjustment.

In a case where the wireless communication device 1 is at a higher temperature than it was in the initial state (after DAC adjustment), the PLO becomes lower than the PLO value in the state S3 (state S4). In the state S4, the output code of the digital baseband signal of the A/D converter 15 is C_S4. Further, in the state S4, the DC offset voltage of the analog baseband signal of the frequency conversion circuit 11 is ΔV_S4.

Accordingly, in a case where the output code of the digital baseband signal has changed from the initial adjustment value C_center, the control circuit 14 gradually increases the gain of the variable gain amplifier 13 until the output code of the digital baseband signal of the A/D converter 15 becomes saturated as C_sat2 (transition from the state S4 to a state S5), as in the case of the initial adjustment. Further, in the transition from the state S4 to the state S5, the DC offset voltage of the analog baseband signal again becomes saturated as ΔV_sat2. This adjustment makes it possible to bring the frequency conversion circuit 11 into an optimum operating state by increasing the PLO to a value that is close to the optimum value PLO_sat until the conversion gain of the frequency conversion circuit 11 becomes saturated as a saturated conversion gain G_sat2.

As described above, a local oscillation signal level adjustment circuit 20 of Embodiment 1 includes: a local oscillation circuit 12 that outputs a local oscillation signal; a variable gain amplifier 13 that amplifies the local oscillation signal level; a frequency conversion circuit 11 that converts a radio signal into an analog baseband signal by using the local oscillation signal level thus amplified; an A/D converter 15 that converts the analog baseband signal into a digital baseband signal; and a control circuit 14 that controls a gain of the variable gain amplifier 13 on a basis of an output code of the digital baseband signal, wherein the control circuit 14 increases the gain of the variable gain amplifier 13 until the output code of the digital baseband signal becomes saturated. Therefore, the local oscillation signal level adjustment circuit 20 can omit a conventionally-needed circuit that detects the level of a local oscillation signal and can adjust the level of a local oscillation signal level with high accuracy. Further, since the DC offset voltage (4V_sat2) in the state S5 can be expected to be sufficiently low, the compensation of the DC offset voltage by the D/A converter 16 can be made simpler than the initial adjustment (i.e., the adjustment from the state S2 to the state S3).

### Embodiment 2

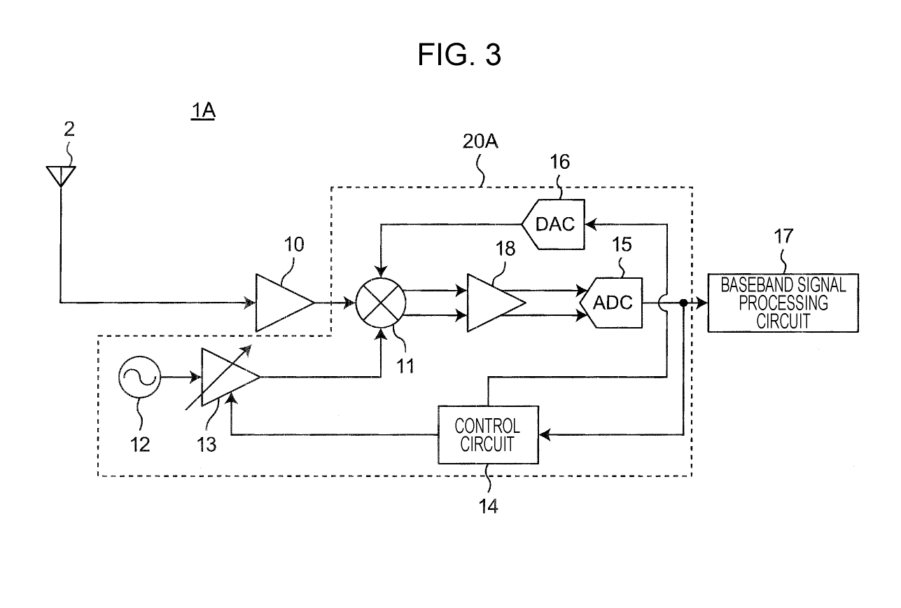

FIG. 3 is a block diagram showing an example configuration of a wireless communication device 1A according to Embodiment 2 of the present disclosure. The wireless communication device 1A is configured in view of increasing the total gain of a receiving circuit to improve the reception sensitivity of the wireless communication device 1 according to Embodiment 1. As compared with the wireless communication device 1 according to Embodiment 1 of FIG. 1, the wireless communication device 1A includes a local oscillation signal level adjustment circuit 20A including a baseband amplifier 18 between the frequency conversion circuit 11 and the A/D converter 15.

The baseband amplifier 18 amplifies an analog baseband signal and outputs the analog baseband signal thus amplified to the A/D converter 15. The control circuit 14 increases the gain of the variable gain amplifier 13 until the output code of the digital baseband signal of the A/D converter 15 becomes saturated (i.e., until the DC offset voltage of the analog baseband signal from the frequency conversion circuit 11 becomes saturated).

As described above, a local oscillation signal level adjustment circuit 20A of Embodiment 2 includes: a local oscillation circuit 12 that outputs a local oscillation signal; a variable gain amplifier 13 that amplifies the local oscillation signal level; a frequency conversion circuit 11 that converts a radio signal into an analog baseband signal by using the local oscillation signal level thus amplified; an A/D converter 15 that converts the analog baseband signal into a digital baseband signal; and a control circuit 14 that controls a gain of the variable gain amplifier 13 on a basis of an output code of the digital baseband signal, wherein the control circuit 14 increases the gain of the variable gain amplifier 13 until the output code of the digital baseband signal becomes saturated. Therefore, the local oscillation signal level adjustment circuit 20A can omit a conventionally-needed circuit that detects the output level of the local oscillation circuit 12 and can adjust the output level (PLO) of the local oscillation circuit 12 with high accuracy. The local oscillation signal level adjustment circuit 20A of Embodiment 2 further includes a baseband amplifier 18 provided between the frequency conversion circuit 11 and the A/D converter 15 to amplify the analog baseband signal. This makes it possible to improve reception sensitivity.

### Summary of the Embodiments

A local oscillation signal level adjustment circuit according to a first aspect of the present disclosure includes: a local oscillation circuit that outputs a local oscillation signal; a variable gain amplifier that amplifies the local oscillation signal level; a frequency conversion circuit that converts a radio signal into an analog baseband signal by using the local oscillation signal level thus amplified; an A/D converter that converts the analog baseband signal into an output code of a digital baseband signal; and a control circuit that controls a gain of the variable gain amplifier on a basis of the output code of the digital baseband signal, wherein the control circuit increases the gain of the variable gain amplifier until the output code of the digital baseband signal becomes saturated.

A local oscillation signal level adjustment circuit according to a second aspect of the present disclosure is the local oscillation signal level adjustment circuit according to the first aspect, further comprising a D/A converter, wherein the control circuit outputs a digital control signal for compensating for the output code of the digital baseband signal to an initial adjustment value, the D/A converter converts the digital control signal into an analog control signal and outputs the analog control signal to the frequency conversion circuit, the frequency conversion circuit converts the radio signal into an compensated analog baseband signal by using the digital control signal and the local oscillation signal level thus amplified.

A local oscillation signal level adjustment circuit according to a third aspect of the present disclosure is the local oscillation signal level adjustment circuit according to the second aspect, wherein in a case where the output code of the digital baseband signal has changed from the initial adjustment value, the control circuit increases the gain of the variable gain amplifier until the output code of the digital baseband signal becomes saturated.

A local oscillation signal level adjustment circuit according to a fourth aspect of the present disclosure is the local oscillation signal level adjustment circuit according to the first aspect, further including a baseband amplifier provided between the frequency conversion circuit and the A/D converter to amplify the analog baseband signal.

A wireless communication device according to a fifth aspect of the present disclosure includes: an antenna that receives a radio signal; a low noise amplifier that amplifies the radio signal; a local oscillation circuit that outputs a local oscillation signal; a variable gain amplifier that amplifies the local oscillation signal level; a frequency conversion circuit that converts the radio signal level thus amplified into an analog baseband signal by using the local oscillation signal thus amplified; an A/D converter that converts the analog baseband signal into an output code of a digital baseband signal; a baseband processing circuit that outputs a demodulated signal obtained by demodulating the output code of the digital baseband signal; and a control circuit that controls a gain of the variable gain amplifier on a basis of the output code of the digital baseband signal, wherein the control circuit increases the gain of the variable gain amplifier until the output code of the digital baseband signal becomes saturated.

A local oscillation signal level adjustment method according to a sixth aspect of the present disclosure includes: outputting, by using a local oscillation circuit, a local oscillation signal; amplifying, by using a variable gain amplifier, the local oscillation signal level; converting by using a frequency conversion circuit, a radio signal into an analog baseband signal by using the local oscillation signal level thus amplified; converting, by using an A/D converter the analog baseband signal into an output code of a digital baseband signal; controlling a gain of the variable gain amplifier on a basis of the output code of the digital baseband signal; and increasing the gain of the variable gain amplifier until the output code of the digital baseband signal becomes saturated.

The present disclosure is useful, for example, as a wireless communication device that uses radio frequency signals in a millimeter-wave band, reduces fluctuations in characteristic resulting from process variability or changes in temperature, and performs a stable reception operation.

What is claimed is:

1. A local oscillation signal level adjustment circuit comprising:
a local oscillation circuit that outputs a local oscillation signal;
a variable gain amplifier that amplifies the local oscillation signal level;
a frequency conversion circuit that converts a radio signal into an analog baseband signal by using the local oscillation signal level thus amplified;
an A/D converter that converts the analog baseband signal into an output code of a digital baseband signal; and
a control circuit that controls a gain of the variable gain amplifier on a basis of the output code of the digital baseband signal,
wherein the control circuit increases the gain of the variable gain amplifier until the output code of the digital baseband signal becomes saturated.

2. The local oscillation signal level adjustment circuit according to claim 1, further comprising a D/A converter, wherein
the control circuit outputs a digital control signal for compensating for the output code of the digital baseband signal to an initial adjustment value,
the D/A converter converts the digital control signal into an analog control signal and outputs the analog control signal to the frequency conversion circuit,
the frequency conversion circuit converts the radio signal into an compensated analog baseband signal by using the digital control signal and the local oscillation signal level thus amplified.

3. The local oscillation signal level adjustment circuit according to claim 2, wherein in a case where the output code of the digital baseband signal has changed from the initial adjustment value, the control circuit increases the gain of the variable gain amplifier until the output code of the digital baseband signal becomes saturated.

4. The local oscillation signal level adjustment circuit according to claim 1, further comprising a baseband amplifier provided between the frequency conversion circuit and the A/D converter to amplify the analog baseband signal.

5. A wireless communication device comprising:
an antenna that receives a radio signal;
a low noise amplifier that amplifies the radio signal;
a local oscillation circuit that outputs a local oscillation signal;
a variable gain amplifier that amplifies the local oscillation signal level;
a frequency conversion circuit that converts the radio signal thus amplified into an analog baseband signal by using the local oscillation signal level thus amplified;
an A/D converter that converts the analog baseband signal into an output code of a digital baseband signal;
a baseband processing circuit that outputs a demodulated signal obtained by demodulating the output code of the digital baseband signal; and
a control circuit that controls a gain of the variable gain amplifier on a basis of the output code of the digital baseband signal,
wherein the control circuit increases the gain of the variable gain amplifier until the output code of the digital baseband signal becomes saturated.

6. A local oscillation signal level adjustment method comprising:
outputting, by using a local oscillation circuit, a local oscillation signal;
amplifying, by using a variable gain amplifier, the local oscillation signal level;
converting, by using a frequency conversion circuit, a radio signal into an analog baseband signal by using the local oscillation signal level thus amplified;
converting, by using an A/D converter the analog baseband signal into an output code of a digital baseband signal;
controlling a gain of the variable gain amplifier on a basis of the output code of the digital baseband signal; and
increasing the gain of the variable gain amplifier until the output code of the digital baseband signal becomes saturated.
